(19) United States
(12) Patent Application Publication
(10) Pub. No.: US 2025/0128473 A1
(43) Pub. Date: Apr. 24, 2025

(54) METHODS AND COLORING SUSPENSIONS FOR COLORING CURABLE BINDER COMPOSITIONS IN ADDITIVE MANUFACTURING PROCESSES

(71) Applicant: SIKA TECHNOLOGY AG, Baar (CH)

(72) Inventors: Didier LOOTENS, Küsnacht (CH); Maxime LIARD, Zürich (CH); Victoria ABPLANALP, Nürensdorf (CH); Léa GARANDEL, Saint mathieu de treviers (FR)

(73) Assignee: SIKA TECHNOLOGY AG, Baar (CH)

(21) Appl. No.: 18/835,239

(22) PCT Filed: Feb. 22, 2022
(86) PCT No.: PCT/EP2022/054455

§ 371 Date: Aug. 1, 2024

(51) Int. Cl. B29C 64/314; B29C 64/165; B33Y 10/00; B33Y 40/00

(52) U.S. Cl. CPC B29C 64/314; B29C 64/165; B33Y 10/00; B33Y 40/00; B29K 2995/0021

(57) ABSTRACT

A method for producing a three-dimensional object from a curable binder composition with an additive manufacturing process, whereby before application of the curable binder composition, at least one, for example at least two, especially at least three, in particular at least four, coloring suspension(s) includes a color pigment and a solvent, especially water, is added to the curable binder composition to color the curable binder composition.

### TECHNICAL FIELD

The invention relates to a method for producing a three-dimensional object from a curable binder composition with an additive manufacturing process whereby at least one coloring suspension is added to color the curable binder composition. Furthermore, the invention is concerned with liquid coloring suspensions for coloring curable binder compositions as well as a kit comprising at least two coloring suspensions.

### BACKGROUND ART

In construction industry, curable binder compositions, such as e.g. mineral binder compositions, are widely used for various applications. Examples of such compositions are mortar, concrete, grout, or screed compositions.

Construction elements made from binder compositions comprising cement as binder typically have greyish colors whereas compositions based on gypsum usually are white. From an architectural and aesthetic point of view, however, other colors often are desirable. Painting of the surfaces of the construction elements is a well know option in this regard. Another approach is to mix color pigments with the binder compositions whereby the construction elements produced from the curable compositions can be colored in depth.

In this regard, US 2016/0221874 A1 (Construction Research & Technology, GmbH) describes for example a colored cementitious composition that is composed of hydraulic cement and a liquid coloring suspension. The liquid coloring suspension contains a polycarboxylate dispersant, a pigment, and a polysaccharide thixotropic additive. The pigment may be an inorganic or organic pigment.

In the construction sector, attempts have also been made for some time to produce geometrically demanding construction elements using additive manufacturing processes. The term “additive manufacturing process” or “additive production” refers to processes in which a spatial object or a molded body is produced by the targeted spatial deposition, application and/or solidification of material.

The deposition, application and/or consolidation of the material, e.g. the curable binder composition, is carried out in particular on the basis of a data model of the object to be generated and in particular layer-by-layer. Each object is typically produced from one or more layers in the additive manufacturing process. Usually, a formless material (e.g. liquids, powders, granulates, etc.) and/or a form-neutral material (e.g. tapes, wires) is used to manufacture an object, which is subjected in particular to chemical and/or physical processes (e.g. melting, polymerizing, sintering, curing). Additive manufacturing processes are also referred to as “generative manufacturing processes” or “3D printing”, among others.

Colorization in additive manufacturing with curable binder compositions can for example be achieved by adding color pigments to the dry powder mix of the binder compositions or by adding colored solutions in the mixed binder compositions. In this regard, WO 2019/048752 A1 (XTREEE) describes for example a method for colorization of cementitious materials in an additive manufacturing process whereby different colors can be added to the cementitious material directly in the extrusion head of a 3D printing apparatus before extrusion of the material.

However, homogeneously distributing color pigments in curable compositions such as e.g. cementitious compositions is a demanding task. This is in particular true in additive manufacturing where the pigments usually need to be pumped through supply lines and homogeneously intermixed in the curable composition in a rather short time interval, e.g. when the color pigments are added directly in the extrusion head of the 3D printing apparatus. It is believed that these difficulties partly are caused by the rheological properties of the color pigments or the solutions comprising the color pigments, which are not ideal for pumping and efficiently intermixing them with curable compositions.

Furthermore, adding color pigments to curable compositions might affect the rheology and setting behavior of the curable composition, especially if added in high concentrations. This also is critical in additive manufacturing since a defined setting behavior of the mineral binder composition is of outmost importance for an efficient and precise build-up of the construction element or the object, respectively.

Thus, there is still a need for new and improved solutions that overcome the aforementioned disadvantages as far as possible.

### DISCLOSURE OF THE INVENTION

It is an object of the present invention to provide improved solutions for colorization of curable binder compositions in additive manufacturing processes. Thereby, preferably, the solutions should affect the additive manufacturing process as well as the rheology and/or the setting behavior of the curable binder compositions as little as possible. Preferably, the solutions should allow for mixing different color tones in an easy and reliable manner.

Surprisingly, it has been found that this object can be achieved by the features of independent claims 1, 15, 16 and 17.

Thus, the present invention is in particular related to a method for producing a three-dimensional object from a curable binder composition with an additive manufacturing process and to liquid coloring suspensions for coloring curable binder compositions for additive manufacturing.

The inventive method is based on the concept that before application of the curable binder composition, at least one, for example at least two, especially at least three, in particular at least four, coloring suspension(s) comprising a color pigment and water is added to the curable binder composition to color the curable binder composition.

Solutions based on this method turned out to be highly beneficial because, the coloring suspensions can be added to the curable binder compositions in the print head and/or in a supply line upstream the print head of a 3D printing apparatus. This allows for changing the color of the curable binder composition instantaneously and in real time without need of cleaning the supply line when changing the color. Also, the curable mineral binder composition can be colored with different colors to produce constructional elements having sections with different colors within the same printing process.

Furthermore, the inventive methods can be implemented in an automated manner for coloring three-dimensional objects with different colors on the basis of a data models of the three dimensional object describing the three dimensional object in terms of structure and color.

The inventive coloring suspensions for coloring curable binder compositions for additive manufacturing comprise:
a) 5-70 wt. %, preferably 25-70 wt.-%, of a color pigment, especially selected from organic pigments and carbon black;
b) 25-70 wt.-% of a solvent, especially water; and
c) Optionally, 0.001-30 wt. %, preferably 0.001-5 wt.-%, of a defoamer,
whereby all proportions are given with respect to overall weight of the coloring suspension.

Surprisingly, it was found that the inventive liquid coloring suspensions are highly beneficial for coloring curable binder compositions for additive manufacturing coloring.

Especially, the liquid coloring suspensions according to the invention can be pumped over quite long distances through small tubes even at rather high pigment concentrations. Put differently, inventive liquid coloring suspension can be prepared with unexpectedly advantageous rheological properties.

Also, the liquid coloring suspensions according to the invention can be metered very precisely to curable binder compositions even at low dosages in the range of 0.001-3 wt.-%.

Furthermore, the inventive coloring suspensions are rather stable. In particular, there is no need for additional stabilizers.

Similarly to paints, different inventive color suspensions can be mixed together beforehand or in the curable binder composition to create new colors with varying intensities. Thereby, colors and intensities in the curable mineral binder composition can be easily controlled by the proportions of the individual color suspensions.

Therefore, the inventive color suspensions are highly suitable for use in additive manufacturing processes.

Particularly preferred embodiments are outlined throughout the description and the dependent claims.

### WAYS OF CARRYING OUT THE INVENTION

A first aspect of the present invention is directed to a liquid coloring suspension for coloring curable binder compositions for additive manufacturing comprising:
a) 5-70 wt. %, preferably 25-70 wt.-%, in particular 40-60 wt. %, most preferably 45-55 wt. %, of a color pigment, especially selected from organic pigments and carbon black;
b) 25-70 wt.-%, in particular 40-60 wt. %, most preferably 45-55 wt. %, of a solvent, especially water; and
c) Optionally, 0.001-30 wt. %, preferably 0.001-5 wt.-% of a defoamer,
whereby all proportions are given with respect to overall weight of the coloring suspension.

The color pigment as such in particular is a solid substance, especially a powder substance.

The color pigment can be an inorganic pigment and/or an organic pigment. Inorganic pigments in particular are meant to be chemical compounds that lack carbon-hydrogen bonds, such as e.g. metal oxides or carbon black. Accordingly, organic pigments in particular are meant to be chemical compounds comprising carbon-hydrogen bonds. Organic pigments encompass metal-organic pigments, such as e.g. phthalocyanine dyes.

The color pigment can for example be an organic dye, a metal-organic dye, a metal oxide, a silicate, a metal phosphate, an aluminate, a carbonate, a hydroxide, a vanadate, a nitrite, a chromate, a sulfide a selenide, a sulfate and/or a carbon black.

An inorganic pigment is for example selected from TiO₂, BaSO₄, Sb₂O₃, ZnO, magnetite, MnO₂, Cd₂SSe, FeO, Fe₂O₃, ZnCrO₄, SnS₂, CdS, BiVO₄, Cr₂O₃, CoZnO₂, CuzCO₃(OH)₂, CaCuSi₄O₁₀, Co-aluminate, ultramarine and/or carbon black.

Carbon black can e.g. be selected from acetylene black, channel black, furnace black, lamp black and/or thermal black.

Especially, the color pigment, in particular the organic pigment, is selected from red, blue, green, magenta and/or yellow pigments. These colors can be used as primary colors to be mixed in varying amounts to produce a gamut of colors.

In particular, the color pigment comprises an organic pigment and an inorganic pigment or the color pigment is a mixture of an organic pigment and an inorganic pigment.

In an especially preferred embodiment, the color pigment is selected from organic pigments and carbon black.

In particular, in this case, the color pigment essentially does not comprise an inorganic pigment other than carbon black. In particular, the color pigment comprises less than 1 wt. %, in particular less than 0.1 wt. %, preferably less than 0.01 wt. %, of an inorganic pigments other than carbon black, with respect to the overall amount of color pigments.

Furthermore, the carbon black in this case preferably is selected from acetylene black, channel black, furnace black, lamp black and/or thermal black.

Surprisingly, it was found that organic pigments can be used at significantly lower concentrations for obtaining a similar or even stronger color tone, when compared with inorganic pigments, such as e.g. oxide-based pigments. Thus, a lower dosage of the suspension is needed and therefore an even lower amount of liquid is added to the binder composition during the additive manufacturing process. This further helps to maintain the rheology and setting behavior of the curable binder composition at a constant level. Also, the organic pigments can be better concentrated in the solvent which furthermore reduces the amount of liquid added in the process and the color tones obtainable in the binder compositions after curing typically are much stronger.

Preferably, the organic pigment is a substance selected from phthalocyanine dyes, quinophthalone dyes, naphthol dyes, diketopyrrolopyrrole dyes, quinacridone dyes, dioxazine dyes, arylide dyes, and/or pyrazolo quinazolone dyes. These substances turned out to be sufficiently stable in curable binder compositions, especially in mineral binder compositions, and at the same time they are capable of coloring the curable binder compositions at rather low dosages.

However, other substances might be suitable as well.

In particular, in these special embodiments in which the color pigment is selected from organic pigments and carbon black, with respect to overall weight of the coloring suspension, the coloring suspension comprises less than 1 wt. %, in particular less than 0.1 wt. %, preferably less than 0.01 wt. %, of an inorganic pigments other than carbon black, especially of oxide based pigments. Nevertheless, for special applications, inorganic pigments can be added at higher proportions, if desired.

The solvent preferably is selected such that the color pigment is suspended in the solvent. For example, the solvent is a polar substance, most preferably water. This is in particular true if the coloring suspension is used for coloring mineral binder compositions.

Optionally, the coloring suspension comprises a defoamer. A defoamer helps to reduce foam generation during mixing of the color pigment, especially the organic pigment, and the solvent.

Preferably the defoamer is selected from water insoluble compounds.

Especially, the defoamer is selected from kerosene, liquid paraffin, animal oil, vegetable oil, sesame oil, castor oil, alkylene oxide adducts thereof, oleic acid, stearic acid and alkylene oxide adducts thereof, diethylene glycol laurate, glycerin monorecinolate, alkenyl succinic acid derivatives, sorbitol monolaurate, sorbitol trioleate, polyoxyethylene monolaurate, polyoxyethylene sorbitol monolaurate, natural wax, linear or branched fatty alcohols and their alkoxylated derivatives, octyl alcohol, hexadecyl alcohol, acetylene alcohol, glycols, polyoxyalkylene glycol, polyoxyalkylene amide, acrylate polyamine, tributyl phosphate, sodium octyl phosphate; aluminum stearate, calcium oleate, silicone oil, silicone paste, silicone emulsion, organic modified polysiloxane, fluorosilicone oil; and/or polyoxyethylene polyoxypropylene adducts.

For example, a suitable defoamer is Agitan® 218, which is available from Münzing Chemie GmbH (Germany). Agitan® 218 is a blend of liquid hydrocarbons, modified fatty compounds, nonionic emulsifiers with silicone.

A proportion of the defoamer can be in the range of 0.001-30 wt. %, preferably 0.001-5 wt.-%, especially 0.01-2 wt. %, in particular 0.1-1.6 wt. %, with respect to the overall weight of the coloring suspension.

Furthermore, the coloring suspension may additionally comprise an additive for controlling the chemical and/or physical properties of a setting curable binder composition. Examples of such additives are described below in connection with the inventive method. For example, a proportion of the additive may be selected in the range of 0.001-30 wt. %, preferably 0.001-10 wt.-%, especially 0.01-5 wt. %, with respect to the overall weight of the coloring suspension.

A further aspect of the present invention is related to a method for producing a coloring suspension as described above. Thereby, the color pigment, especially selected from organic pigments and carbon black, is mixed with the solvent and optionally the defoamer. Most preferably, the so obtained mix is subjected to a high-speed mixing process. This allows for obtaining a highly homogeneous and stable coloring suspension.

Another aspect of the present invention is directed to a kit comprising at least two, especially at least three, in particular at least four, coloring suspensions as described above, whereby each of the at least two coloring suspensions comprise a different color pigment. In particular, the color pigments comprised in each of the at least two coloring suspensions comprise an organic pigment, an inorganic pigment or a mixture of an organic pigment and an inorganic pigment. Especially, the color pigments comprised in each of the at least two coloring suspensions are selected from organic pigments and carbon black.

Such a kit can be used to mix different colors from the at least two coloring suspensions in an easy and reproducible manner.

Most preferably, the kit comprises at least one coloring suspension with a color pigment having a color different than black, in particular selected from organic pigments, and a coloring suspension with a color pigment selected from carbon black. Especially, the color pigment having a color different than black is selected from red, blue, green, magenta and/or yellow pigments.

Even more preferred, the kit comprises at least three coloring suspensions with a color pigment having a color different than black, in particular selected from organic pigments, whereby each of the color pigments has a different color, and a further coloring suspension with a color pigment selected from carbon black. Especially, the color pigments having a color different than black are selected from red, blue, green, magenta and/or yellow pigments. This allows for mixing all kind of colors in with a wide range of intensities.

Furthermore, the kit may comprise at least one, two, three of four coloring suspensions comprising an additive for controlling the chemical and/or physical properties of a setting curable binder composition. Examples of such additives are described below in connection with the inventive method. For example, a proportion of the additive may be selected in the range of 0.001-30 wt. %, preferably 0.001-10 wt.-%, especially 0.01-5 wt. %, with respect to the overall weight of the coloring suspension.

Also, the kit may additionally comprise an additive for controlling the chemical and/or physical properties of a setting curable binder composition as a separate component. Examples of such additives are described below in connection with the inventive method.

Another aspect of the present invention is directed to a method for producing a three-dimensional object from a curable binder composition, especially a mineral binder composition, with an additive manufacturing process, in particular in a generative free-space process, whereby before application of the curable binder composition, at least one, for example at least two, especially at least three, in particular at least four, coloring suspension(s) comprising a color pigment and a solvent, especially water, is added to the curable binder composition to color the curable binder composition.

The at least one coloring suspension used in the inventive method is a coloring suspension comprising a color pigment and a solvent, especially water. Thereby, the suspension comprises for example 1-99 wt. %, in particular 5-95 wt. %, of color pigment and 1-99 wt. % in particular 5-95% wt. %, of solvent.

Especially, the color pigment and/or the solvent is chosen as described above in connection with the first aspect or the inventive coloring suspension, respectively. However, the at least one coloring suspension might be different from the coloring suspensions according to the first aspect.

Nevertheless, in an especially preferred embodiment, the at least one coloring suspension used in the inventive method is a coloring suspension according to the first aspect of the invention described above.

The curable binder composition is for example a reactive resin, a mineral binder composition or a mixture thereof. Most preferably, the curable binder composition is a mineral binder composition.

A reactive resins is, in particular, a liquid or liquefiable synthetic resin which cures by polymerization or polyaddition to form duromers. For example, unsaturated polyester resins, vinyl ester resins, acrylic resins, epoxy resins, polyurethane resins and/or silicone resins can be used.

The term “mineral binder” stands in particular for a binder which reacts in the presence of water in a hydration reaction to form solid hydrates or hydrate phases. This can be, for example, a hydraulic binder (e.g. cement or hydraulic lime), a latent hydraulic binder (e.g. slag), a pozzolanic binder (e.g. fly ash) or a non-hydraulic binder (e.g. gypsum or white lime).

A “mineral binder composition” is accordingly a composition containing at least one mineral binder. In particular, it contains the binder, aggregates, water and optionally one or more additives. Aggregates may be, for example, aggregates, gravel, sand (in natural and/or processed (e.g. crushed) form) and/or fillers.

In particular, the at least one coloring suspension is added to the curable binder composition in the setting state. In case of a mineral binder compositions, the compositions are in the setting state after mixing the mineral binder and optionally further components, such as e.g. aggregates, with the mixing water. Thus, the expression “the curable binder composition in the setting state” in particular means that the curable binder composition is in a condition in which the setting of the binder in the curable binder composition has started but is not yet complete.

In particular, the curable binder composition is produced in the setting state by mixing of the components of the curable binder composition in a mixing unit. Most preferably, the curable binder composition is continuously produced in the setting state, especially during the application of the curable binder composition.

Preferably, the at least one coloring suspension is added to the curable binder compositions with a supply device and an inlet nozzle. Preferably the supply device and/or the inlet nozzle is controllable, in particular with a control unit. This allows for controlling the dosage of the coloring suspension.

More preferably, the at least one coloring suspension is added to the curable binder composition with a color mixing device, which is configured for separately adding at least two, especially at least three, in particular at least four, different coloring suspensions to the curable binder composition.

Especially, the control unit is connected with a flow meter, a pressure sensor and/or a dosing valve for controlling the flow rate or proportion of the at least one color suspension. In the case of more than one color suspension, the control unit is connected with at least one flow meter, pressure sensor and/or a dosing valve for controlling the flow rate or proportion of each of the color suspensions independently.

In a possible embodiment, each of the at least one coloring suspension is separately introduced into the curable binder composition without being premixed before.

For example, for each of the coloring suspensions, the color mixing device comprises a separate supply device and a separate inlet nozzle. This allows for separately introducing each of the coloring suspensions into the curable binder composition without being premixed before.

In another highly preferred embodiment, all of the at least one coloring suspensions are premixed before introducing the mixed coloring suspensions into the curable binder composition.

Thereby, for example, the color mixing device comprises a manifold with separate inlet ports for each of the coloring suspensions and a common outlet port in fluid communication with a single inlet nozzle. This allows for separately dosing each of the coloring suspensions into the manifold and premixing the coloring suspensions before introducing the mixed coloring suspensions via the single inlet nozzle into the curable binder composition. This turned out to be surprisingly beneficial for reducing dead volumes in the print head and results in a reduced cleaning effort. Furthermore, an even more homogeneous distribution of the color pigments in the curable composition can be achieved.

Thus, in a preferred embodiment, at least two, especially at least three, in particular at least four coloring suspensions, are added to the curable binder composition simultaneously and/or in sequence, whereby each of the at least two colorings suspensions comprises a different color pigment.

Preferably, a proportion of the at least one color suspension, especially of each of the at least two coloring suspensions, added to the curable binder composition is controlled with a control unit.

The control unit preferably is configured for controlling the proportion of the at least one coloring suspension for obtaining a colored curable binder composition with a previously selected target color.

According to a preferred embodiment, the proportion of the at least one color suspension, especially the proportion of each of the at least two coloring suspensions, is changed at least once, especially several times, during production of the three-dimensional object in order to obtain a three-dimensional object with at least two different colors, especially several different colors.

Further preferred, a proportion of the at least one coloring suspension is determined based on a previously established relation between the proportion of the at least one coloring suspension in the curable binder composition and coordinates in a color model, especially a HSV model, representing the target color.

Especially, for different types of curable binder compositions, individual relations between the proportion of the at least one coloring suspension in the curable binder composition and coordinates in the color model are established. This improves color fidelity of the three-dimensional object.

A color model is an abstract mathematical model describing the way colors can be represented as tuples of numbers, typically as three or four values or color components. HSV stands for hue, saturation and value, which are the cylindrical coordinates of the HSV color model. The H coordinate ranges from 0-360°, the S coordinate ranges from 0-100% and the V coordinate ranges from 0-100%. The HSV color model represents an alternative representation of the RGB (red, green, blue) color model.

Especially, the proportion of the at least one coloring suspension is determined based on a previously established relation, especially an experimentally determined relationship, between the proportion of the at least one coloring suspension in the curable binder composition and the coordinates in a color model, especially a HSV model, representing the target color.

The relation previously established can for example be determined experimentally by adding coloring suspensions with a given concentration into a test composition and determining the color coordinates obtained.

Thereby, preferably, when determining the proportions of the at least one coloring suspension, a previously established relation, especially an experimentally determined relationship, between the ratio of at least two different coloring suspensions in the curable binder composition and at least one coordinate in a color model, especially the H coordinate in a HSV model, is considered.

Further preferred, when determining the proportions of the at least one coloring suspension, a previously established relation between the total concentration of at least two different coloring suspensions in the curable binder composition and at least one coordinate in a color model, especially the S coordinate and/or the V coordinate in a HSV model, is considered. Thereby, preferably, the at least one coordinate is different from the at least one coordinate in the last paragraph.

Especially, a proportion of the at least one coloring suspension is changed at least once, especially at least twice during the production of the three-dimensional object, especially to obtain a three-dimensional structure with different colors in sections.

When the target color is changed at least once, especially at least twice, during production of the three-dimensional object, the proportion of the at least one color suspension, especially the proportion of each of the at least two coloring suspensions, preferably is adjusted by the control unit in order to change the color of the colored curable binder composition accordingly.

Further preferred, a proportion of the at least one coloring suspension, especially of each of the at least two coloring suspensions, added to the curable binder composition is determined by taking into consideration the flow properties, e.g. the flow rate, of the curable material used in the additive manufacturing process. Especially, the flow properties are determined with a measuring unit including an ultrasonic transducer. The flow properties preferably are measured upstream the print head, especially in the supply line. In this case, the control unit preferably is configured for controlling the proportion of the at least one coloring suspension, especially of each of the at least two coloring suspensions, accordingly.

In particular, the at least one coloring suspension is added with proportions of 0.001-3 wt.-%, especially 0.01-1.5 wt.-%, for example, 0.1-1 wt. %, with respect to the curable mineral binder composition.

Preferably, the at least one coloring suspension is added such that in sections of the curable binder composition comprising the at least one coloring suspension, the color pigment is homogeneously distributed throughout the curable binder composition.

After addition of the at least one coloring suspension, the curable binder composition preferably passes at least one static and/or dynamic mixer. This helps to homogenously distribute the color pigments in the curable binder compositions. If more than one coloring suspension is added, the static and/or dynamic mixer will effectively mix different color pigments to obtain a mixed color in the in the curable binder composition.

Preferably, the curable binder composition is applied by means of a print head movable in at least one spatial direction to form the three-dimensional structure. Thereby, especially, the curable binder composition is applied layer by layer.

Preferably, the at least one coloring suspension is added to the curable binder composition, which in particular is in the setting state, after having passed at least mixing stage.

Especially, the at least one coloring suspension is added to the curable binder composition in the print head and/or in a supply line upstream the print head, especially between the at least one mixing stage and the print head.

If present, the above described color mixing device preferably is arranged in the print head and/or in the supply line upstream the print head.

In a further preferred embodiment, an additive for controlling the chemical and/or physical properties of the curable binder composition in the setting state is added to the curable binder composition in the setting state in the print head, in a supply line upstream the print head and/or together with the coloring suspensions, especially in the color mixing device, in particular via an additive supply device, optionally with an additive inlet nozzle. The additive supply device and/or the additive inlet nozzle preferably are controllable, in particular with the above described control unit.

The additive preferably is a substance capable of controlling and/or modifying the flow properties and/or the setting behavior of the curable binder composition. Preferably, the additive is selected from an accelerator, a retarder, a rheological aid, a surfactant, and/or a superplasticizer, especially for mineral binder compositions.

In a possible embodiment, the additive for controlling the chemical and/or physical properties of the setting curable binder composition is added to the curable binder composition separately from the at least one coloring suspension(s).

A surfactant may have the beneficial effect of stabilizing the coloring suspension when mixed with the curable binder composition in the setting state.

Surfactants are well known to the specialist and are summarized, for example, in “Surfactants and Polymers in aqueous solutions” (Wiley-VCH, K. Holmberg et al, 2nd Edition, 2007). Surfactants can be non-ionic surfactants, cationic surfactants, anionic surfactants or zwitterionic surfactants.

Suitable surfactants in the context of the present invention include lipids such as cholates, glycocholates, fatty acid salts, glycerides, glycolipids and phospholipids. These may be derived from natural sources or may be synthetically produced. Non-ionic lipids are preferred in certain embodiments.

Suitable anionic surfactants include, in particular, alkyl ether carboxylates, alkyl sulfates, alkyl ether sulfates, lauryl ether sulfonates, naphthalene sulfonates, alkyl sulfosuccinates, alkyl phosphates, alkyl ether phosphonates and alkyl benzene sulfonates.

Suitable nonionic surfactants are in particular alkylphenol alkoxylates, alkoxylated polysaccharides, fatty acid amide alkoxylates, alkoxylated alkylamines with an alkyl radical consisting of 6-20 carbon atoms, alkylglycosides, alkylglucamides, hydrophobized starch, and hydrophobized cellulose. Preferred alkoxylates in this context are particularly ethoxylates.

Suitable cationic surfactants contain, in particular, ammonium groups or quaternary nitrogen atoms and also have at least one long-chain alkyl radical. Examples of cationic surfactants are betaines, amidobetaines, imidazolines and amine N-oxides.

In a further preferred embodiment, all of the at least one coloring suspensions and the additive for controlling the chemical and/or physical properties of the setting curable binder composition are premixed before introducing the mix of the coloring suspensions and the additive into the curable binder composition.

Especially, at least one, in particular two, three or four coloring suspensions each are provided as a mixture with the additive for controlling the chemical and/or physical properties of the setting curable binder composition. These mixtures and optionally additional additive then can be introduced into the curable binder composition either separately or after mixing with one or more of the other coloring suspensions and/or additional additive.

Especially preferred, the additive for controlling the chemical and/or physical properties of the setting curable binder composition is added to the setting curable binder composition in the color mixing device, especially via the above described manifold. Thereby, preferably, the manifold comprises an inlet port for each of the coloring suspensions, at least one inlet port for the additive and a common outlet port in fluid communication with a single inlet nozzle. This allows for separately dosing each of the coloring suspensions and the additive into the manifold and premixing the coloring suspensions and the additive before introducing the mix via the single inlet nozzle into the curable binder composition.

This further reduces dead volumes in the print head and cleaning effort. Additionally, it is easier to achieve a homogeneous distribution of the color pigments and the additive in the curable composition.

A further preferred embodiment comprises the following steps:
a) after addition of the at least one color suspension, especially after addition of the at least two color suspensions, to the curable binder composition, the color of the colored curable binder composition is measured with a color measuring device before and/or during application in order to obtain a real color of the colored curable binder composition;
b) a color deviation between the measured real color and the previously selected target color is determined in the control unit;
c) by considering the color deviation, the proportion of the at least one coloring suspension, especially the proportion of each of the at least two coloring suspensions, is adjusted in order to compensate for the color deviation, especially such that the real color of the colored curable binder composition is adjusted to correspond to the selected target color;
whereby steps a)-c) are continuously repeated at least in selected periods, especially permanently, during production of the three-dimensional object.

Thereby, the dolor deviations can be compensated in real-time. This allows for producing three-dimensional objects indeed having the desired target colors.

A color measuring device in particular is a device capable of measuring the color of an object and providing the color of the object in terms of coordinates of a color model, e.g. a HSV color model.

In a further advantageous embodiment, after application of the curable binder composition with the additive manufacturing process, an outer surface of the applied curable binder composition and/or an outer surface of the three-dimensional object produced with the additive manufacturing process is hydrophobized at least in part or completely.

Hydrophobization helps for color preservation, for example in case of weathering. This is in particular true for outer surfaces having greyish and/or black colors.

Thus, in a preferred embodiment, at least parts of the outer surface having a greyish and/or black color are hydrophobized.

For example, hydrophobization can be achieved by coating, especially by spraying, the respective outer surface with a hydrophobization agent. A hydrophobization agent can e.g. be selected from silane-, siloxane- and/or siliconate-based hydrophobization agents. Such agents are commercially available, e.g. from Sika Services AG (Switzerland) under the tradename Sikaguard®. However other agents, e.g. oil-, fat- and/or wax-based agents, can be used as well. Another highly preferred aspect of the invention is related to a method for producing a three-dimensional object having at least one desired target color, especially more than one target color, whereby the three-dimensional object is produced from a curable binder composition with an additive manufacturing device and comprises the steps of:
a) receiving in a control unit of the additive manufacturing device a target color, especially from a user interface and/or a machine interface;
b) with the control unit of the additive manufacturing device, determining a proportion of at least one color suspension, especially proportions of at least two coloring suspensions, in the curable binder composition required to obtain a colored curable binder composition having the desired target color, whereby the determination is based on a pre-determined color model stored in a memory unit of the additive manufacturing device;
c) adding the at least one color suspension, especially the at least two coloring suspensions, with the proportions determined in step b) to the curable binder composition, with one or more inlet device(s), especially one or more actuator(s), that is/are controlled with the control unit; and
d) applying the colored curable binder composition by means of a printing head to form the three-dimensional object.
whereby steps c)-d), especially steps a)-d), are continuously repeated during production of the three-dimensional object.

The method in particular is a computer-implemented method.

The suspensions used in this method might be the same as described above or different ones. In addition, in this method, all of the above described method features and steps can be implemented in addition. Nevertheless, it is possible to implement the method without it, if desired.

Preferably, in step b) the determination of the proportion of the at least one color suspension, especially the proportions of the at least two coloring suspensions, in the curable binder composition required to obtain a colored curable binder composition having the desired target color, is based on a previously established relation between the proportions of the at least one coloring suspension in the curable binder composition and coordinates in the color model, especially a HSV model, representing the target color.

Thereby, preferably, for different curable binder composition, individual relations between the proportion of the at least one coloring suspension in the curable binder composition and coordinates in the color model are established. This improves color fidelity of the three-dimensional object.

Especially, at least two different target colors are received in the control unit in step a), especially one after the other in time, for producing a three-dimensional object with at least two differently colored sections.

The target color received in the control unit in step a) in particular is determined before on the basis of a data model of the three dimensional object describing the three dimensional object in terms of structure and color. This allows for automatically providing a desired target color for different sections of the three-dimensional object.

Further preferred, the method comprises the following steps:
a) the color of the colored curable binder composition is measured with a color measuring device before and/or during application in order to obtain a real color of the colored curable binder composition;
b) a color deviation between the measured real color and the previously selected target color is determined in the control unit;
c) by considering the color deviation, the proportion of the at least one coloring suspension, especially the proportion of each of the at least two coloring suspensions, is adjusted in order to compensate for the color deviation, especially such that the real color of the colored curable binder composition is adjusted to correspond to the selected target color;
whereby steps a)-c) are continuously repeated at least in selected periods, especially permanently, during production of the three-dimensional object.

In particular, all of the methods described above can be performed with devices as described in the following. Thus, any features described in the following in connection with the devices can be implemented in the methods described above accordingly.

In a further aspect, the invention is directed to an additive manufacturing device having means adapted to execute the methods described above and/or a device for producing a three-dimensional object from a curable binder composition with an additive manufacturing process, especially a robotic system, whereby the device comprises a supply device and an inlet nozzle for adding at least one coloring suspension, especially at least two or more coloring suspension, into the curable binder composition for obtaining a colored curable binder composition, whereby the supply device and/or the inlet nozzle is controllable with a control unit, and the control unit is configured for controlling the proportion of the at least one coloring suspension for obtaining the colored curable binder composition with a previously selected target color.

In particular, the device is configured for performing the above described methods. Thus, any features described in connection with the methods above can be implemented in the device accordingly.

Especially, the device comprises a flow meter, a pressure sensor and/or a dosing valve connected with the control unit for controlling the flow rate or proportion of the at least one color suspension. If the device is configured for adding more than one coloring suspension into the curable binder composition, the device preferably comprises a flow meter, a pressure sensor and/or a dosing valve connected with the control unit for each of the color suspensions. This allows for controlling the flow rate or proportion of each of the color suspensions independently.

The control unit preferably is configured such that the proportion of the at least one coloring suspension is automatically determined based on the coordinates in a color model, especially a HSV model, representing the desired target color.

Especially, the control unit is configured such that the proportion of the at least one coloring suspension is determined based on a previously established relation, especially an experimentally determined relationship, between the proportion of the at least one coloring suspension in the curable binder composition and the coordinates in a color model, especially a HSV model, representing the target color.

The relation previously established can for example be determined experimentally by adding coloring suspensions with a given concentration into a test composition and determining the color coordinates obtained.

Thereby, preferably, the control unit is configured such that when determining the proportions of the at least one coloring suspension, a previously established relation, especially an experimentally determined relationship, between the ratio of at least two different coloring suspensions in the curable binder composition and at least one coordinate in a color model, especially the H coordinate in a HSV model, is considered.

Further preferred, the control unit is configured such that when determining the proportions of the at least one coloring suspension, a previously established relation between the total concentration of at least two different coloring suspensions in the curable binder composition and at least one coordinate in a color model, especially the S coordinate and/or the V coordinate in a HSV model, is considered. Thereby, preferably, the at least one coordinate is different from the at least one coordinate in the last paragraph.

Especially, the device further comprises a color mixing device, which is configured for separately adding at least two, especially at least three, in particular at least four, different coloring suspensions to the curable binder composition.

In particular, in a first embodiment, the color mixing comprises a separate supply device and a separate inlet nozzle for each of the coloring suspensions. Especially, each of the separate supply devices and/or each of the separate inlet nozzles are controllable with the control unit. This allows for separately introducing each of the coloring suspensions into the curable binder composition without being premixed before.

In another highly preferred embodiment, the color mixing device comprises a manifold with a separate inlet port for each of the coloring suspensions and a common outlet port in fluid communication with a single inlet nozzle. This allows for separately dosing each of the coloring suspensions into the manifold and premixing the coloring suspensions before introducing the mixed coloring suspensions via the single inlet nozzle into the curable binder composition.

The device preferably comprises a print head movable in at least one spatial direction to form the three-dimensional structure. The print head has a print head outlet, especially an outlet nozzle, to apply the curable binder composition. If desired, the print head can comprise a controllable outlet, especially in the form of an openable and closable outlet nozzle. In this case, the openable and closable outlet nozzle preferably is controllable with the control unit.

In particular, the device comprises a supply line for supplying the curable binder composition to the print head.

Preferably, there is at least one mixing stage or mixing unit, especially a static and/or dynamic mixer, arranged upstream the supply device and the inlet nozzle or upstream the color mixing device, if the latter is present. Especially, the at least one mixing stage is arranged such that the curable binder composition is mixed before entering the supply line and/or when passing the supply line.

Preferably, the supply line is in fluid communication with one or more receptacles comprising individual components of the curable binder composition, e.g. binder, water, aggregates and/or additives, which can be mixed in the a least one mixing stage before and/or during entering the supply line.

In particular, the device comprises at least one mixer, especially a static and/or dynamic mixer, which is arranged downstream the supply device and the inlet nozzle for adding at least one coloring suspension into the curable binder composition or downstream the color mixing device, if the latter is present. In particular, the at least one mixer is arranged between (i) the print head outlet, especially the outlet nozzle, and (ii) the supply device and the inlet nozzle for adding at least one coloring suspension into the curable binder composition, or between (i) the print head outlet, especially the outlet nozzle, and (ii) the color mixing device.

Especially, the supply device and the inlet nozzle for adding at least one coloring suspension into the curable binder composition or the color mixing device are arranged such that the at least one coloring suspension can be added to the curable binder composition in the print head and/or in the supply line upstream the print head, especially between the at least one mixing stage and the print head.

In a further preferred embodiment, the device comprises an additive supply device, optionally with an additive inlet nozzle, which is configured for adding an additive to the curable binder composition in the print head, in the mixing device and/or in the supply line upstream the print head. The additive is an additive for controlling the chemical and/or physical properties of the setting curable binder composition as described above. The additive supply device and/or the additive inlet nozzle preferably are controllable, in particular with the above described control unit.

Especially preferred, the manifold as described above is configured for additionally adding the additive for controlling the chemical and/or physical properties of the setting curable binder composition to the setting curable binder composition.

Thus, preferably, the mixing device comprises a manifold having an inlet port for each of the coloring suspensions, at least one inlet port for an additive and a common outlet port in fluid communication with a single inlet nozzle. As explained above, this allows for separately dosing each of the coloring suspensions and the additive into the manifold and premixing the coloring suspensions and the additive before introducing the mix via the single inlet nozzle into the curable binder composition.

Further preferred, the device comprises a measuring unit, which preferably is arranged upstream the print head and which is designed to determine the flow properties, e.g. the flow rate, of the curable binder composition in the setting state in the supply line. Especially, the measuring unit includes an ultrasonic transducer. The measuring unit preferably is connected with the control unit. In this case, the control unit preferably is configured for controlling the proportion of the at least one coloring suspension in consideration of the flow properties of the curable binder composition in the setting state in the supply line. According to particularly preferred embodiments, the flow rate of the at least one coloring suspension or the mix of coloring suspensions is proportional to the flow rate of the binder composition in the setting state.

In addition, the device preferably comprises a color measuring device, which in particular is configured for measuring the color of the curable binder composition and providing the color of the curable binder composition in terms of coordinates of a color model, e.g. a HSV color model. Such devices are commercially available.

For example, the color measuring device is arranged in the print head or at the print head outlet, especially the outlet nozzle. In the latter case, the color of the curable binder composition can be measured directly after exiting the print head.

In particular, the control unit of the device includes a processor, a memory unit, and a plurality of interfaces for receiving data and a plurality of interfaces for controlling individual components of the device.

A further aspect of the invention is directed to a computer program comprising instructions to cause the device described above to execute the methods as described above.

Another aspect of the present invention is directed to the use of a coloring suspension as described above or of a kit as described above for coloring a curable binder composition, especially in an additive manufacturing process.

Further advantageous embodiments of the invention are evident from the exemplary embodiments.

### BRIEF DESCRIPTION OF THE DRAWINGS

The drawings used to explain the embodiments show:

FIG. 1 An exemplary system for producing a three-dimensional colored object from a curable binder composition with an additive manufacturing process, whereby the system is configured such that coloring suspensions can be added separately into the curable binder composition;

FIG. 2 Another exemplary system for producing a three-dimensional colored object from a curable binder composition with an additive manufacturing process, whereby the systems comprises a manifold for premixing the coloring suspensions before adding the mixed coloring suspensions to the curable binder composition;

FIG. 3a-c Graphs representing the relationship between the H, S and V coordinates and the concentrations of each of four different coloring suspensions;

FIG. 4 The dependence of the H coordinate on the mixing ratio of a blue and a red coloring suspension (blue/red color mix);

FIG. 5 The dependence of the S coordinate on the total concentration of a red/yellow color mix;

FIG. 6 The dependence of the V coordinate on the total concentration of a red/blue as well as a red/yellow color mix;

FIG. 7 The dependence of the V coordinate on the total concentration of a yellow/blue color mix;

FIG. 8 The effect of the black pigment on the V coordinate on different colors;

FIG. 9A user interface for selecting a target color.

### EXEMPLARY EMBODIMENTS

### Coloring Suspensions

The following coloring suspensions were prepared by mixing the components with a high-speed mixer:

TABLE 1

| | | Pigment/ | Water | Defoamer |
|---|---|---|---|---|
| | Color | proportion [wt. %] | [wt. %] | [wt. %] |
| B | blue | Xfast BI 7080¹⁾/50 | 49 | 1 |
| Y | yellow | Xfast YII 0962¹⁾/50 | 49 | 1 |
| R | red | Xfast Red 3855¹⁾/50 | 49 | 1 |
| Bk | black | Xfast Bk 0066¹⁾/50 | 49 | 1 |

¹⁾Available from BASF (Germany)

Xfast BI 7080, Xfast YII 0962 and Xfast Red are organic pigments with the colors indicated in table 1 whereas Xfast Bk 0066 is a carbon black based pigment.

Test with Coloring Suspensions

A comparison has been carried out between the coloring suspensions described above and reference suspensions with inorganic pigments (SikaColor® granules available from Sika USA) instead of organic pigments. Thereby, standard mortars have been colored with the coloring suspensions.

It was found that the same color can be reached with up to 10 times less product with the inventive suspensions when compared with the reference suspensions based on inorganic SikaColor pigments. For example, for obtaining a mortar composition with the same red color, 3 wt. % of the suspension based on SikaColor was needed, whereas with the inventive suspension only 0.3 wt. % was needed.

Thus, the inventive suspensions are highly effective.

### Method and Device for Additive Manufacturing

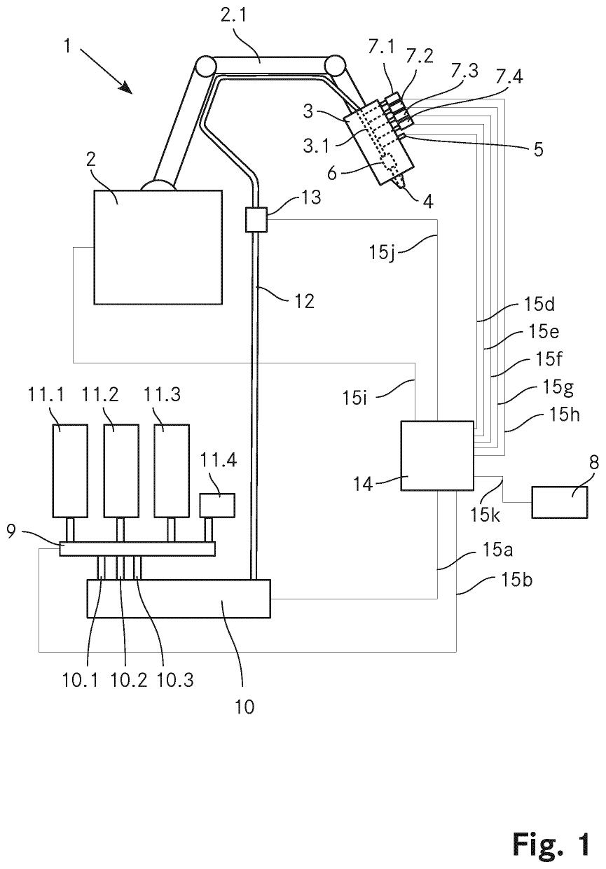

FIG. 1 schematically shows an exemplary system 1 for producing a three-dimensional colored object from a curable binder composition with an additive manufacturing process.

The system 1 comprises a movement device 2 with a movable arm 2.1. A print head 3 is attached to the free end of the arm 2.1, which can be moved by the arm 2.1 in all three spatial dimensions. Thus, the print head 3 can be moved to any position in the working area of the motion device 2.

Inside, the print head 3 has a tubular passage 3.1 passing through from the end face facing the arm 2.1 (at the top in FIG. 1) to the opposite and free end face. The tubular passage is configured for conveying a curable binder composition. At the free end, the passage 3.1 opens into an outlet nozzle 4.

The print head 3 comprises a first inlet device 5 consisting of a supply device, e.g. a pump, and an inlet nozzle, which opens into passage 3.1. Through the inlet nozzle of the inlet device 5, an additive, for example a rheological aid, a surfactant, and/or an accelerator, can be added to the curable binder composition flowing through the passage 3.1 as required.

Additionally, the print head 3 comprises four additional inlet devices 7.1, 7.2, 7.3, 7.4, each comprising a separate reservoir with a coloring suspension (e.g. as described above), a supply device and inlet nozzle opening into passage 3.1. The inlet devices 7.1, 7.2, 7.3, 7.4 are configured for individually adding the coloring suspensions comprised in the reservoirs into passage 3.1 or the curable binder composition, respectively.

Furthermore, inside the print head 3, downstream with respect to the inlet devices, a dynamic mixer 6 is arranged in the passage 3.1, which additionally mixes the curable binder composition, the additive and the coloring suspensions.

The system 1 for applying a curable building material also has a feed device 9 which corresponds on the input side with three containers 11.1, 11.2, 11.3 and an additive reservoir 11.4. Each of the three containers 11.1, 11.2, 11.3 contains one component of the curable building material. The first component, which is present in the first container 11.1, is a dry mineral binder composition, e.g. cement or dry mortar. The second component, which is present in the second container 11.2, consists of water, for example. The third component present in the third reservoir 11.3 is, for example, a superplasticizer in the form of a polycarboxylate ether. In the additive reservoir 11.4 there is present, for example, a rheological aid in the form of modified cellulose and/or a microbial polysaccharide.

On the output side, the feed device 9 has three separate outlets, each of which is connected to one of three inlets 10.1, 10.2, 10.3 of a mixing device 10. The feed device 9 also has individually controllable metering devices (not shown in FIG. 1), so that the individual components in the individual containers 11.1, 11.2, 11.3 can be metered individually into the mixing device 10.

A further outlet of the feed device is connected to the inlet nozzle 5 (not shown in FIG. 1), so that additive can be fed from the additive reservoir 11.4 into the inlet nozzle 5 via a further metering device of the feed device 9.

The mixing device 10 is designed as a dynamic mixer and comprises, in addition thereto, an integrated conveying device in the form of a screw conveyor. In the mixing device, the individually metered components are mixed together and conveyed into the flexible line 12 attached to the outlet side of the mixing device 10. In operation, the mixing and conveying of the curable binder composition can take place continuously.

The curable binder composition can be conveyed into the print head 3 via the flexible line 12, which opens into the tubular passage 3.1, and continuously applied through the outlet nozzle 4.

Also, part of the system 1 is a measuring unit 13, which is integrated into the delivery line 12 in the area between the mixing device 10 and the print head 3. The measuring unit includes, for example, an ultrasonic transducer which is designed to determine the flow properties of the curable material.

A central control unit 14 of the system 1 includes a processor, a memory unit, and a plurality of interfaces for receiving data and a plurality of interfaces for controlling individual components of the system 1.

In this regard, the mixing device 10 is connected to the control unit 14 via a first control line 15a, while the feeding device 9 is connected to the control unit 14 via a second control line 15b. As a result, the individual components in the containers 11.1, 11.2, 11.3 can be metered into the mixing device 10 via the central control unit in accordance with predetermined recipes stored in the control unit and conveyed into the flexible line 12 at adjustable conveying rates.

The inlet devices 5, 7.1, 7.2, 7.3. 7.4 are each connected to the control unit 14 via a separate control line 15d, 15e, 15f, 15g, 15h as well and can be controlled or monitored by the control unit 14.

The movement device 2 is also connected to the control unit 14 via a further control line 15i. This means that the movement of the print head 3 can be controlled via the control unit 14.

Similarly, the measuring unit 13 is connected to the control unit 14 by a control line 15j, so that data recorded in the measuring unit characterizing the flow properties can be transmitted to the control unit 14.

Furthermore, the control units 14 is connected with a selector unit 8 with a user interface that allows for selecting a target color.

The control unit 14 is thereby configured, for example, in such a way that:
(i) that the addition rates of the three components of the curable building material with the feeding device 9 are controlled in dependence on the flow properties of the curable building material in the flexible line determined via the measuring unit 13;
(ii) the addition rate of the additive via the inlet device 5 is controlled depending on the flow properties of the curable building material determined via the measuring unit 13 and the structure of the object to be created;
(iii) the movement device 2, and thus the position of the print head 3, is controlled as a function of a model of the object to be produced stored in the data memory of the control unit 14;
(iv) the memory unit comprises a previously established relation between the proportions of the coloring suspension in the curable binder composition and coordinates in a color model, especially a HSV model, representing a given target color.
(v) the addition rates and/or proportions of the colored suspensions via the inlet devices 7.1, 7.2, 7.3, 7.4 are individually controlled depending on a target color previously selected with the selector unit 8.

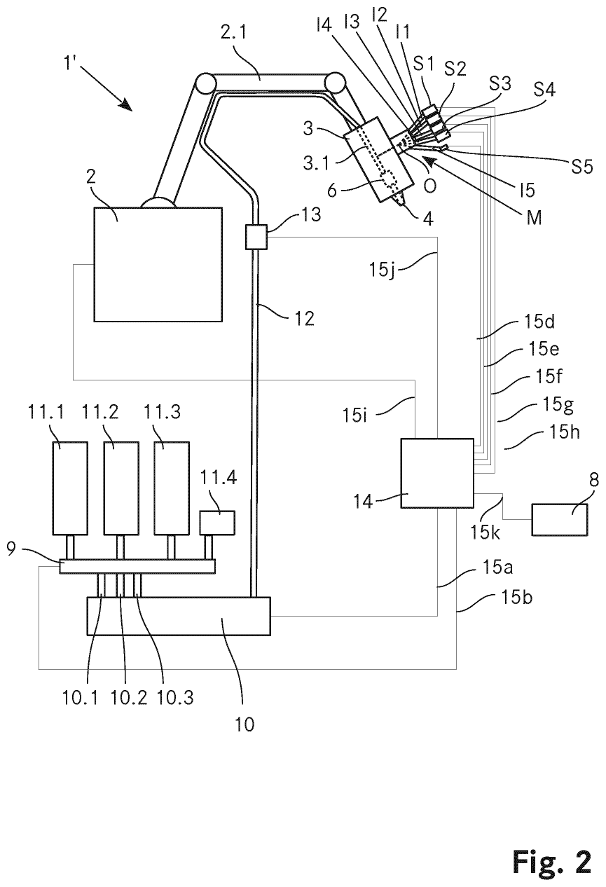

FIG. 2 schematically shows another exemplary system 1′ for producing a three-dimensional colored object from a curable binder composition with an additive manufacturing process.

The system 1′ is essentially identical in design with system 1 of FIG. 1. However, instead of the inlet device 5 and the four additional inlet devices 7.1, 7.2, 7.3, 7.4, system 1′ comprises a manifold M.

Specifically, the manifold M comprises five separate inlet ports I1, I2, I3, I4, I5, which lead to a common outlet port O with a single inlet nozzle opening into passage 3.1.

Each of four first inlet ports I1, I2, I3, I4 is connected with an inlet device S1, S2, S3, S4 comprising a separate reservoir with a coloring suspension (e.g. as described above) and a supply device, e.g. a pump. The inlet devices S1, S2, S3, S4 are configured for individually adding the coloring suspensions comprised in the reservoirs into the respective inlet ports I1, I2, I3, I4.

The fifth inlet port I5 is connected with a further inlet device S5 comprising a supply device, e.g. a pump. The inlet device S5 is configured for providing an additive, for example a rheological aid, to the inlet port I5.

In operation, the coloring suspensions provided through inlet ports I1, I2, I3, I4 and the additive provided through inlet port I5 come together and become intermixed in the manifold M. The so obtained mixture then is supplied via the common outlet O and the single inlet nozzle into passage 3.1.

The inlet devices S1, S2, S3, S4, S5 are each connected to the control unit 14 via a separate control line 15c, 15d, 15e, 15f, 15g, 15h as well and can be controlled or monitored by the control unit 14.

Similar to system 1, the control unit 14 of system 1′ is thereby configured, for example, in such a way that:
(i) that the addition rates of the three components of the curable building material with the feeding device 9 are controlled in dependence on the flow properties of the curable building material in the flexible line determined via the measuring unit 13;
(ii) the addition rate of the additive via the inlet device S5 is controlled depending on the flow properties of the curable building material determined via the measuring unit 13 and the structure of the object to be created;
(iii) the movement device 2, and thus the position of the print head 3, is controlled as a function of a model of the object to be produced stored in the data memory of the control unit 14;
(iv) the memory unit comprises a previously established relation between the proportions of the coloring suspension in the curable binder composition and coordinates in a color model, especially a HSV model, representing a given target color.
(v) the addition rates and/or proportions of the colored suspensions via the inlet devices S1, S2, S3, S4 are individually controlled depending on a target color previously selected with the selector unit 8.

### Colorization of Mortar Compositions

The relation between a pigment proportion of each of the coloring suspensions (B, Y, R, and Bk; cf. table 1) with respect to the weight of the mortar and the color parameters in the HSV color model were established in a cementitious mortar composition optimized for 3D printing. The cementitious mortar composition used was similar to the composition described in WO 2020/187633 A1, page 39, line 9—page 40, line 8.

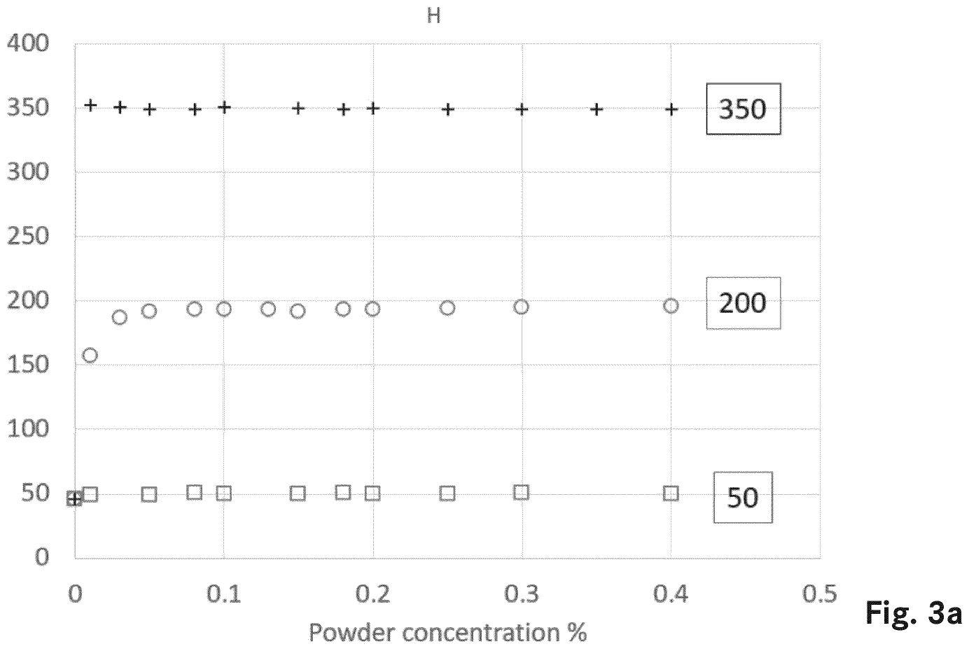

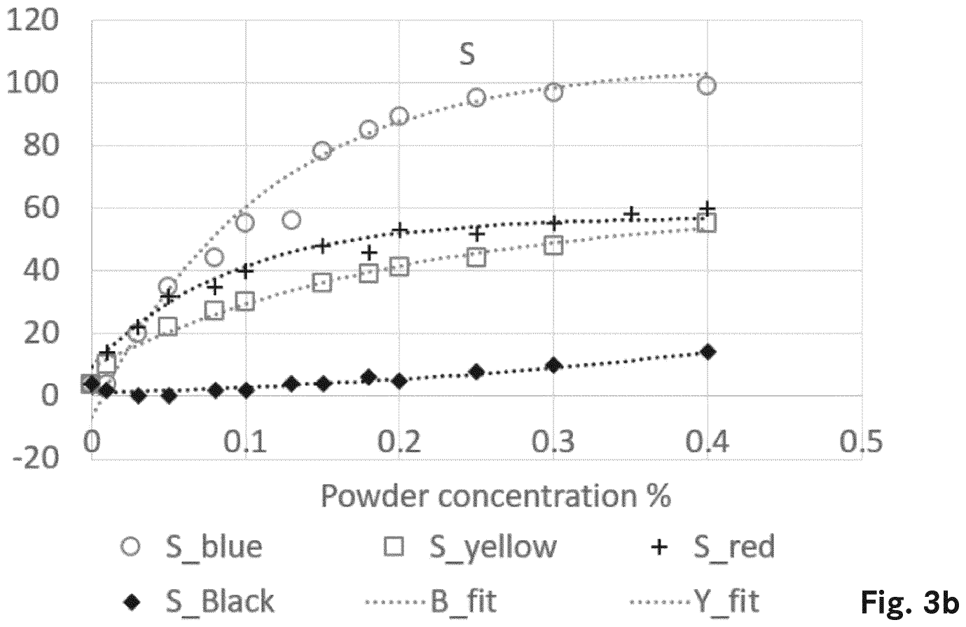

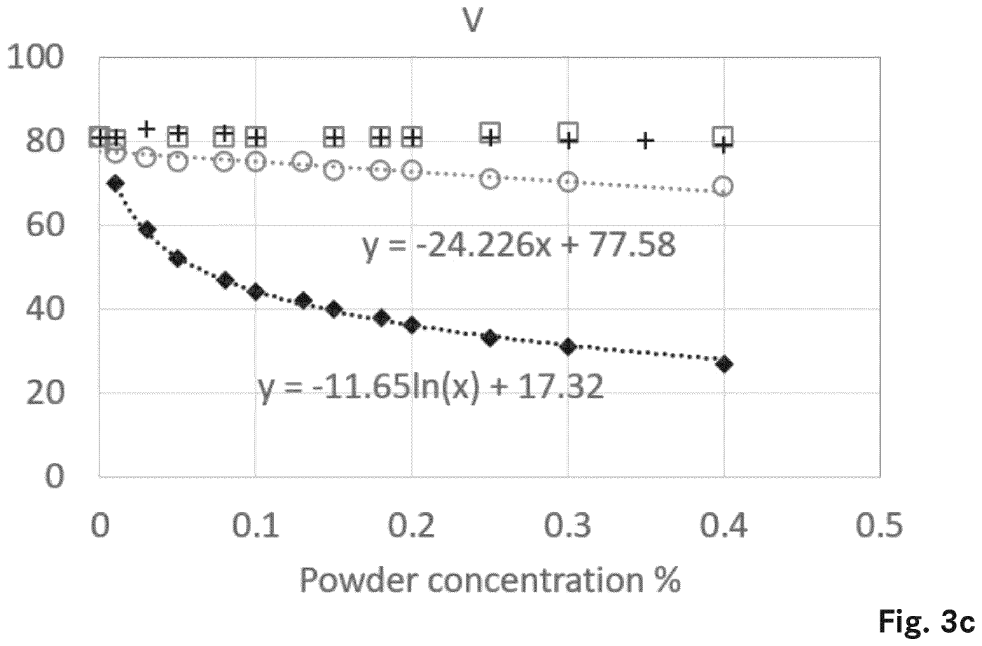

FIG. 3a-c show the corresponding graphs (the powder proportion corresponds to the pigment proportion). It can be observed that colored mortar composition have a constant H (=hue) value independent of the amount of pigment in the composition: 350° for red, 200° for blue and 50° for yellow. This observation agrees with the definition of the color space as H illustrates the shade of the pigment.

The coordinate S, i.e. the saturation value according to HSV-model, is increasing with the concentration differently for each color. While red and yellow have quite a similar evolution of S, blue is more powerful, as it almost reaches 100% for the same concentration. On the other hand, the black pigments do not seem to have a big impact on the saturation.

The curves have been experimentally fitted to allow a simple calculation of a desired saturation value from the concentration.

Finally, in the case of coordinate V, i.e. the brightness value according to HSV-model, red and yellow also have similar behavior whereby V is essentially constant around a value of 80, independently of the concentration. Whereas the addition of blue or black decrease the V, but not with the same intensity. Indeed, black has a greater influence on V than blue. Both evolutions were experimentally fitted, with a linear function for blue and a logarithmic function for black.

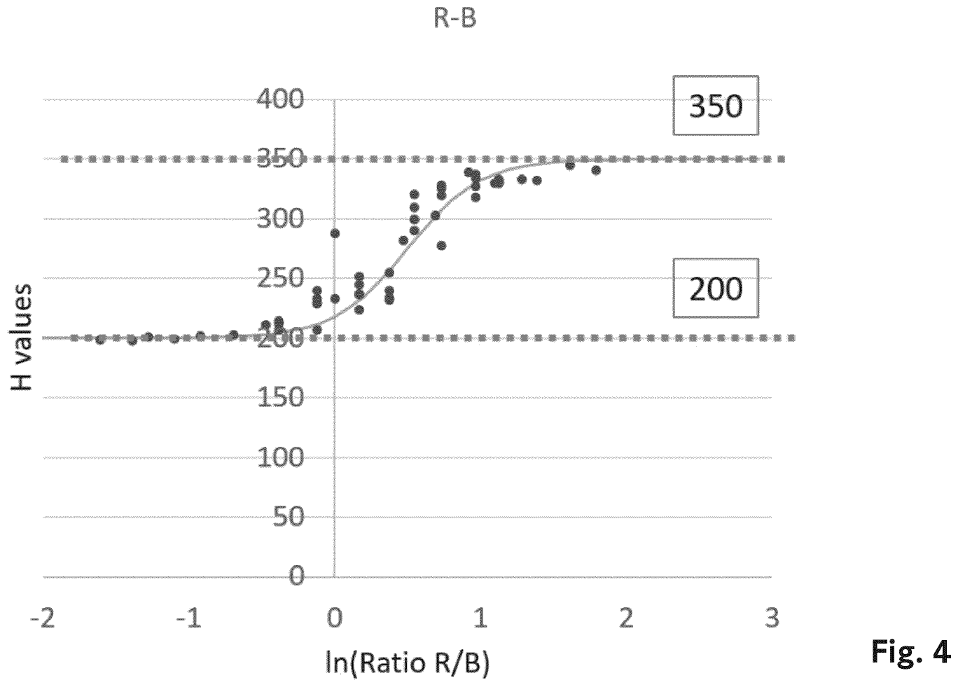

Color combinations were characterized by the ratio between two different coloring suspensions. Three mixes were analyzed: red-yellow, red-blue and yellow-blue. The first observations were that new shades or H values, respectively, were reached by modifying the ratio of two coloring suspensions and saturation increased with the total concentration of pigments. The H values obtained were always between the two corresponding primary H values. For instance, it can be seen in FIG. 4 that for the mix red-blue all H values are between H_{red}=350° and H_{blue}=200° depending on the mix ratio between the quantity of red pigments and blue pigments.

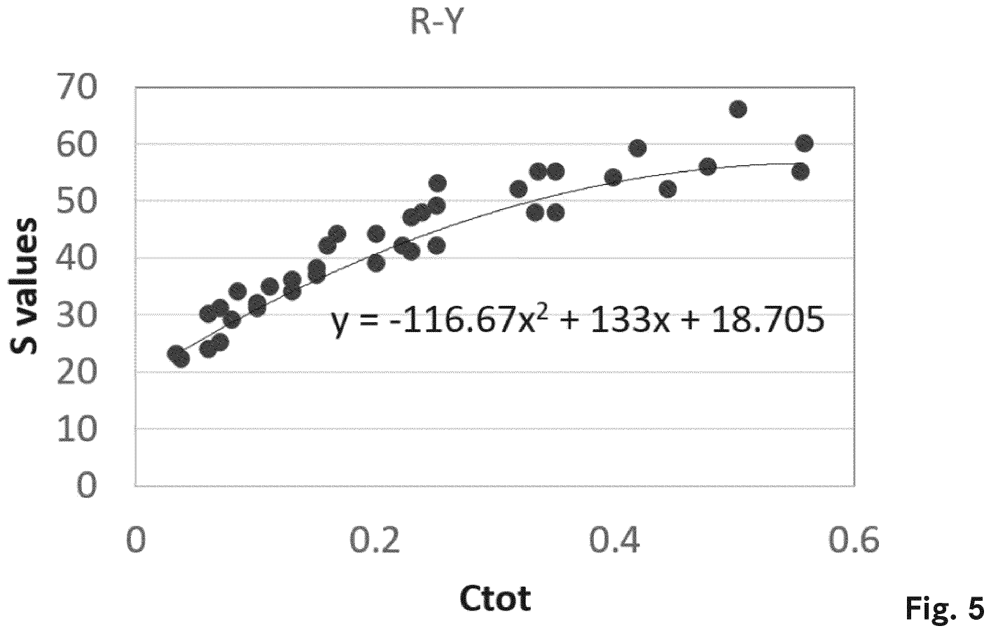

For the mixes, the S values depend only on the total concentration (Cₜₒₜ) of pigments and this evolution can be fitted e.g. with a polynomial function, as shown in FIG. 5 for the red-yellow combination.

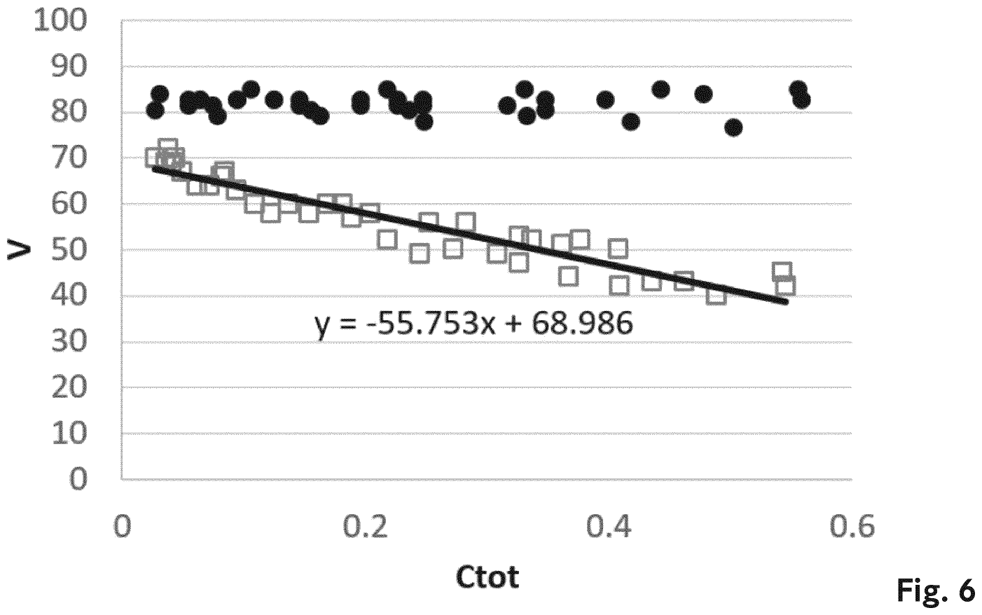

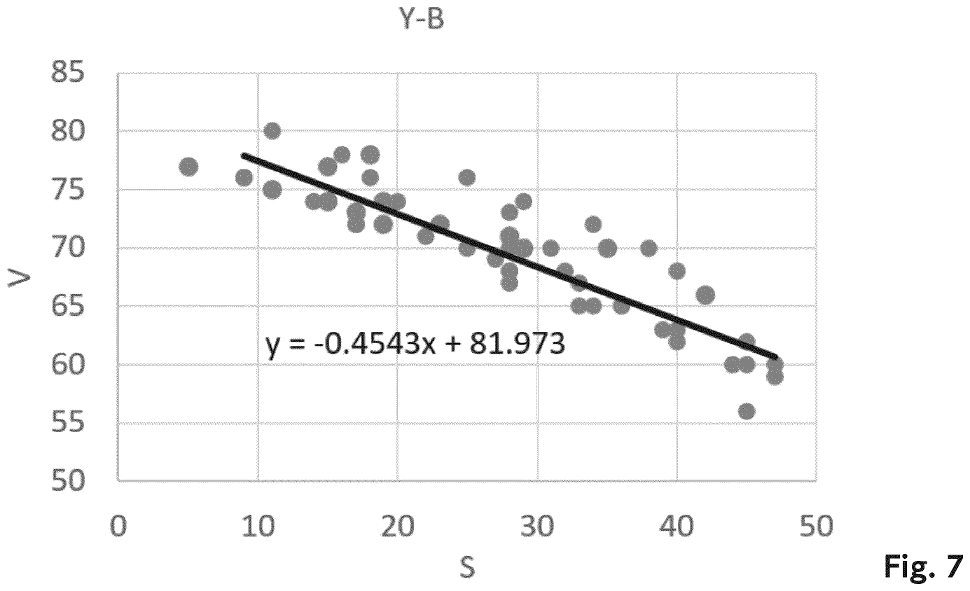

Finally, the V values, are dependent on the nature of the mix. For red-yellow, V was globally constant with values around 83% as shown in FIG. 6. In contrast, the V values decreases linearly for the others mixes, according to the total pigment's concentration for red-blue and yellow-blue mixes, cf. FIGS. 6 and 7. Each of these evolutions can be experimentally fitted to easily calculate the V coordinate.

Evidently, a wide spectrum of colors is obtainable by combining the three primary coloring suspensions B, Y, and R (cf. table 1).

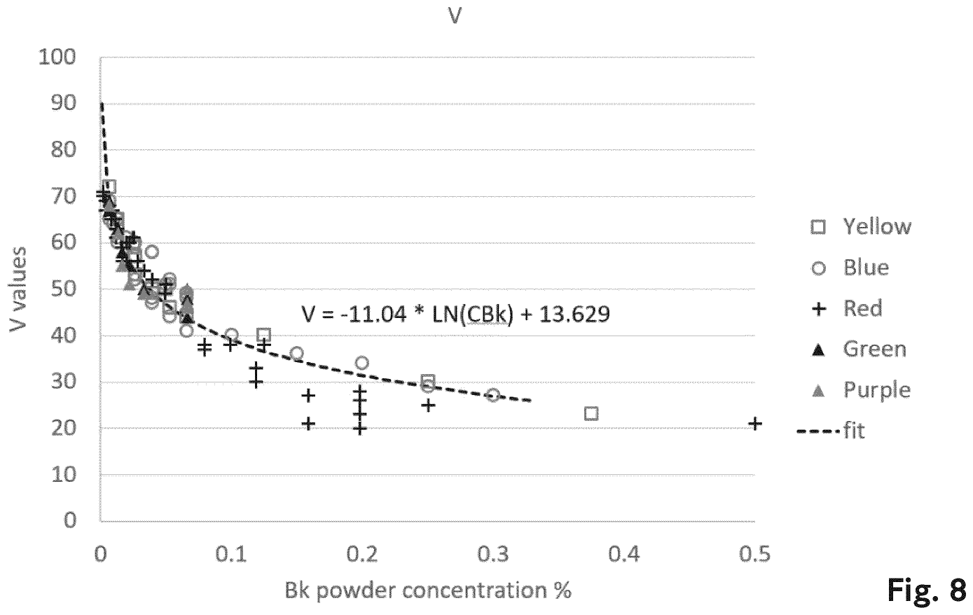

When adding the black coloring suspension Bk, the V values of all colors and mixes are strongly decreased following a logarithmic tendency as shown in FIG. 8.

Thus, based on the above discussed relations it is possible to calculate the concentrations of each coloring suspension in order to obtain a mineral binder composition with a desired target color (given for example in the HSV color model).

For mortar compositions with different compositions, the relations between the pigment proportions of each of the coloring suspensions (B, Y, R, and Bk) and the color parameters in the HSV color model preferably are established again in order to achieve a color trueness as accurate as possible.

### Calculation of Concentrations

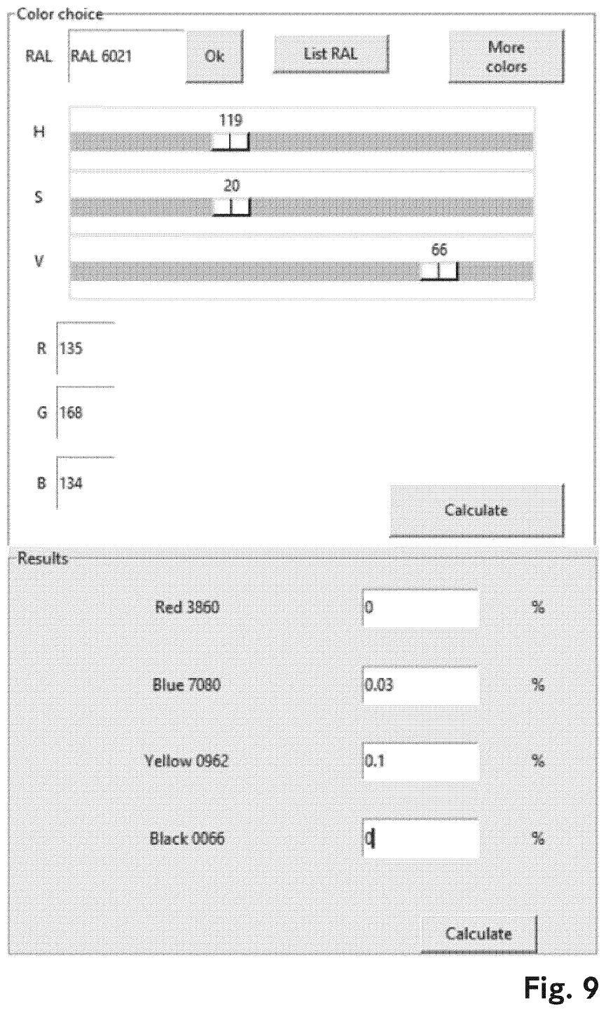

In order to calculate the concentrations of each coloring suspension to obtain a mineral binder composition with a desired target color, a special software was developed. The software can be implemented in the control unit 14 or an external computer device. Target colors can be set with the selector unit 8 with a user interface. An exemplary user interface is shown in FIG. 9. The software permits the entry of a desired target color by the user and then determines the concentrations of coloring suspension based in the previously determined relations between concentrations of the coloring suspensions and the color coordinates H, S and V. Alternatively, the target colors can be given in the RAL system, whereby the RAL numbers are transformed to corresponding HSV coordinates by the software.

The calculations are separated between primary colors (i.e. colors corresponding to the primary coloring suspensions B, Y, and R) and mixed colors (i.e. mixtures of these primary colors).

In the case of primary colors, only the S value requested is used to estimate the concentrations from the experimental fit, as the H value is a constant value specific to each coloration suspension.

In the case of mixed colors, it is more difficult as the calculation depends on each mix. Thereby, the desired H value of the target color requested can be obtained by controlling the ratio of two coloring suspensions. The ratio can be calculated by solving the corresponding system of equations (see for example FIG. 4). Likewise, the S value of the target color requested can be obtained by controlling the total concentration (see for example FIG. 5) by solving the corresponding system of equations. From that it is easy to calculate each concentration. Finally, the V is calculated from the obtained concentrations and compared to the V value of the target color requested in order to estimate the quantity of Black to be added.

For instance, if user requests a brown color with HSV=(30°, 50%, 60%), the software will recognize that H=30° can be obtained from the yellow-red mix with a ratio of approximately yellow/red=7.34 and for this same mix a saturation S of 50% is reached with a total concentration of 0.33%. Then, based on the ratio of yellow and red and the total concentration, the individual concentrations of red and yellow pigments can easily be calculated to C_{yellow}=0.29% and C_{red}=0.04%. Finally, for this mix V=83%, so V needs to be decreased by 23% to obtain the targeted 60%, which corresponds to the concentration of 0.025% of the black pigment.

### Printing Tests

Tests with the device and methods as described above showed that the inventive coloring suspensions are highly suitable for coloring three-dimensional structures in additive manufacturing. Due to the rather low concentrations needed, the additional water introduced into the setting mineral binder composition in the print head does not significantly affect the rheology and setting behavior of the composition. Therefore, it is possible to print three-dimensional structures with varying colors without need to adjust the printing process or the curable mineral binder composition.

It will be appreciated by those skilled in the art that the present invention can be implemented in other specific forms without departing from the spirit or essential characteristics thereof. The presently disclosed embodiments and embodiments are therefore considered in all respects to be illustrative and not restricted.

1. Method for producing a three-dimensional object from a curable binder composition with an additive manufacturing process, whereby before application of the curable binder composition, at least one coloring suspension comprising a color pigment and a solvent is added to the curable binder composition to color the curable binder composition.

2. The method according to claim 1, wherein before adding the at least one coloring suspension, the curable binder composition is produced in the setting state.

3. The method according to claim 1, whereby at least two coloring suspensions are added to the curable binder compositions simultaneously and/or in sequence, whereby each of the at least two coloring suspensions comprises a different color pigment.

4. The method according to claim 1, whereby all of the at least one coloring suspensions are premixed before introducing the mixed coloring suspensions into the curable binder composition.

5. The method according to claim 1, whereby a proportion of the at least one color suspension added to the curable binder composition is controlled with a control unit, wherein the control unit is configured for controlling the proportion of the at least one coloring suspension for obtaining a colored curable binder composition with a previously selected target color.

6. The method according to claim 5, whereby the proportion of the at least one coloring suspension is determined based on a previously established relation between the proportions of the at least one coloring suspension in the curable binder composition and coordinates in a color model representing the target color.

7. The method according to claim 1, whereby the curable binder composition is applied by means of a print head movable in at least one spatial direction to form the three-dimensional structure.

8. The method according to claim 7, whereby the at least one coloring suspension is added to the mineral binder composition in the print head and/or in a supply line upstream the print head.

9. The method according to claim 6, whereby
a) the color of the colored curable binder composition is measured with a color measuring device before and/or during application in order to obtain a real color of the colored curable binder composition;
b) a color deviation between the measured real color and the previously selected target color is determined in the control unit;
c) by considering the color deviation, the proportion of the at least one coloring suspension is adjusted in order to compensate for the color deviation, so that the real color of the colored curable binder composition is adjusted to correspond to the selected target color;
whereby steps a)-c) are continuously repeated at least in selected periods during production of the three-dimensional object.

10. A method according to claim 1 for producing a three-dimensional object having at least one desired target color, whereby the three-dimensional object is produced from a curable binder composition with an additive manufacturing device, whereby the method comprises the steps of:
a) receiving in a control unit of the additive manufacturing device a target color;
b) with the control unit of the additive manufacturing device, determining a proportion of at least one color suspension in the curable binder composition required to obtain a colored curable binder composition having the desired target color, whereby the determination is based on a pre-determined color model stored in a memory unit of the additive manufacturing device;
c) adding the at least one color suspension with the proportions determined in step b) to the curable binder composition, with one or more inlet device(s) that is/are controlled with the control unit; and
d) applying the colored curable binder composition by means of a print head to form the three-dimensional object.
whereby steps c)-d) are continuously repeated during production of the three-dimensional object.

11. The method according to claim 10, whereby in step b) the determination of the proportion of the at least one color suspension in the curable binder composition required to obtain a colored curable binder composition having the desired target color, is based on a previously established relation between the proportions of the at least one coloring suspension in the curable binder composition and coordinates in the color model representing the target color.

12. The method according to claim 10, whereby at least two different target colors are received in the control unit for producing a three-dimensional object with at least two differently colored sections.

13. The method according to claim 10, whereby the target color received in the control unit in step a) is determined on the basis of a data model of the three dimensional object describing the three dimensional object in terms of structure and color.

14. The method according to claim 10, whereby:
a) the color of the colored curable binder composition is measured with a color measuring device before and/or during application in order to obtain a real color of the colored curable binder composition;
b) a color deviation between the measured real color and the previously selected target color is determined in the control unit;
c) by considering the color deviation, the proportion of the at least one coloring suspension is adjusted in order to compensate for the color deviation, so that the real color of the colored curable binder composition is adjusted to correspond to the selected target color;
whereby steps a)-c) are continuously repeated at least in selected periods during production of the three-dimensional object.

15. The method according to claim 1, whereby an additive for controlling the chemical and/or physical properties of the curable binder composition in the setting state is added to the curable binder composition in the setting state in the print head, in a supply line upstream the print head and/or together with the coloring suspensions, the additive being selected from an accelerator, a retarder, a rheological aid, a surfactant, and/or a superplasticizer.

16. An additive manufacturing device having means adapted to execute the steps of the method of claim 1.

17. A computer program comprising instructions to cause the device of claim 16 to execute the steps of the method.

18. A liquid coloring suspension for coloring curable binder compositions, for use in a method according to claim 1, comprising:
a) 5-70 wt.-% of a color pigment;
b) 25-70 wt.-% of a solvent; and
c) optionally, 0.001-30 wt.-% of a defoamer,
whereby all proportions are given with respect to the overall weight of the coloring suspension.

19. The liquid coloring suspension according to claim 18, whereby the color pigment is selected from organic pigments and carbon black, wherein the organic pigment is selected from red, blue, green, magenta and/or yellow pigments.

20. The liquid coloring suspension according to claim 18, whereby the color pigment is a mixture of an organic pigment and an inorganic pigment.

21. The liquid coloring suspension according to claim 18, whereby the organic pigment is a substance selected from phthalocyanine dyes, quinophthalone dyes, naphthol dyes, diketopyrrolopyrrole dyes, quinacridone dyes, dioxazine dyes, arylide dyes, and/or pyrazolo quinazolone dyes.

22. The liquid coloring suspension according to claim 18, whereby with respect to overall weight of the coloring suspension, the suspension comprises less than 1 wt % of an inorganic pigments other than carbon black.

23. The liquid coloring suspension according to claim 18, whereby the defoamer is selected from water insoluble compounds.

24. The liquid coloring suspension according to claim 18, whereby the defoamer is selected from kerosene, liquid paraffin, animal oil, vegetable oil, sesame oil, castor oil, alkylene oxide adducts thereof, oleic acid, stearic acid and alkylene oxide adducts thereof, diethylene glycol laurate, glycerin monorecinolate, alkenyl succinic acid derivatives, sorbitol monolaurate, sorbitol trioleate, polyoxyethylene monolaurate, polyoxyethylene sorbitol monolaurate, natural wax, linear or branched fatty alcohols and their alkoxylated derivatives, octyl alcohol, hexadecyl alcohol, acetylene alcohol, glycols, polyoxyalkylene glycol, polyoxyalkylene amide, acrylate polyamine, tributyl phosphate, sodium octyl phosphate; aluminum stearate, calcium oleate, silicone oil, silicone paste, silicone emulsion, organic modified polysiloxane, fluorosilicone oil; and polyoxyethylene polyoxypropylene adducts.

25. A kit comprising at least two coloring suspensions according to claim 18, whereby each of the at least two colorings suspensions comprises a different color pigment.
